(19) United States
(12) Patent Application Publication
(10) Pub. No.: US 2007/0250587 A1
(43) Pub. Date: Oct. 25, 2007

(54) Method for allowing exchange of permissible information between users in a hosting website

(76) Inventor: Daniel Neville Roberts, London (GB)

Correspondence Address: DANIEL ROBERTS, 14 HARDCASTLE GARDENS, BOLTON, BL2 4NZ, omitted

(21) Appl. No.: 11/711,068

(22) Filed: Feb. 27, 2007

(30) Foreign Application Priority Data
Apr. 20, 2006 (GB) 0607799.4

(51) Int. Cl. G06F 15/16

(52) U.S. Cl. 709/206

(57) ABSTRACT

Method for exchanging permissible information between a sender and recipient that are connected to a data network through a hosting website. Textual information is exchanged between the sender and recipient using an accessible electronic dictionary that contains a set of permissible words, excluding combinations of characters that are not permitted by the hosting website. An algorithm may also be used to exclude words under certain circumstances. When a message is composed by the sender and sent to a recipient, it is first redirected to the hosting website. Only when this has verified that the words used appear in the dictionary of permissible words, is it directed to the recipient. Otherwise, the outgoing message is rejected and the sender notified that the message comprises non-permissible words. When permitted by the website, for example after a payment is received, the sender and recipient are allowed to exchange messages using any words.

### FIELD OF THE INVENTION

The present invention relates to the field of information exchange between users in a hosting Website. More particularly, the invention relates to a method for providing means of information exchange between users while preventing exchange of impermissible information, such as the disclosure of contact data between users prior to the payment of a fee to the host Website.

### BACKGROUND OF THE INVENTION

One of the Internet's advantages is the ability to connect people of common interests together in a hosting Website, to accomplish their goals. For example, many websites offer match-making services, where people may post their personal details and browse the site to seek a companion or a soul-mate. In another example, websites offer dealing services, where sellers and buyers seek each other for striking business deals. Nevertheless, one of the main concerns of these “broker” Websites is the collecting of a payment fee for the brokering services. Some of the broker sites demand a subscription fee from each user prior to entering the site and viewing the posted offers. The subscription fee may vary from entry fees to time limited subscription fees and so on. However, these subscription fee methods decrease the number of customers, as the users are reluctant to pay before viewing the available offers, or at least making an initial contact with the people posting these offers. Another method, used by broker sites, involves collecting fees only from users posting their offers, and allowing free access to all other users who want to view these offers. For example, in some of the marketing websites the sellers pay a fee and advertise their merchandise to the public, whereas the buyers may browse the site freely and buy the advertised goods. Once again, this method requires the sellers to pay the fee prior to knowing if their merchandise attracts any attention. Another method used by broker sites allows users to post their offers freely and browse the site freely without allowing any communication, or allowing a strictly limited communication, between the users. Only after a fee is paid, are the users allowed full communication. For example, a match-making site may allow all users to sign in, advertise their personal details, referred to hereinafter as offers, and browse the site for free. Once a user is interested in one of the offers advertised on the site, he may only signal his interest to the originator of the offer. The signal is usually limited to preset sentences, as the brokering site does not want the participating users to exchange personal contact details between themselves prior to paying the fee. However, since the user is limited to preset sentences, he may find it impossible to acquire relevant information about the posted offer prior to paying the fee and therefore be unwilling to pay the fee. Only after a fee is paid does the brokering site allow full communication between the users.

Therefore, a method is needed for allowing information exchange between two users in a brokering site, to help the users establish the value of the potential contact, without allowing the exchange of contact details such as phone numbers or e-mails prior to payment.

U.S. patent Ser. No. 10/870,269 (Lunati) discloses a method for correcting electronic text composed over a web based e-mail system. Words typed that are not in the system dictionary are highlighted to the user for correction. Alternative words may be suggested to the user, who is then able to select one of these and correct the message. The system does not disallow the sending of a message with words that are not in the dictionary such as names, numbers, and other explicitly prohibited words. It also provides no means for allowing or disallowing words under certain conditions. The method does not disallow messages which may be used to communicate undesired content.

U.S. Pat. No. 6,782,510 discloses a method for controlling the language contents of a document. The method uses a modifiable electronic dictionary which contains inappropriate words. The document words are compared with the dictionary words and each time a comparison is found the word is highlighted and a suggestion of a similar, more appropriate, word is shown. The patent does not describe a method for preventing a user from communicating contact information in messages. WO 97/50259 and JP2004094781 methods similarly censor messages using dictionaries of prohibited words. They are not designed to only allow messages containing only permitted words.

WO 01/59545 discloses a method for providing anonymous internet transaction for protecting a user from involuntarily disclosing his contact details. The method described makes use of a privacy agent which monitors the transactions between the users. The privacy agent compares the words in the messages communicated between users, with the accounts information the users entered prior to entering the Website. Any correlation, full or partial, between the accounts details and the communicated message words results in the routing of the sent message from its intended address back to its originator for erasing said contact information. Nevertheless, if a user communicates contacting details different from the details in the account information or any other information useful to get in contact with another user, the privacy agent cannot detect it.

It is an object of the present invention to provide a method for operating a Website which allows users to exchange relevant information without disclosing contact details.

It is another object of the present invention to provide a method for monitoring, detecting, and preventing any disclosure of contact details during the exchange of information.

It is still another object of the present invention to provide a method for monitoring, detecting, and preventing the use of any other inappropriate or undesired language in message transactions between users of a Website.

Other objects and advantages of the invention will become apparent as the description proceeds.

### SUMMARY OF THE INVENTION

The present invention is directed to a method for exchanging permissible information between a user being the sender and a user being the recipient, that are connected to a data network through a hosting website that is connected to the data network. Means are provided for exchanging textual information between the sender and the recipient. An electronic dictionary that is connected to the data network is also provided. This dictionary contains a set of permissible words, excluding any combination of characters that are not permitted by the hosting website. The sender composes an outgoing message containing the textual information and whenever he sends the outgoing message to a recipient, the outgoing message is redirected to the hosting website. The hosting website verifies that the words used in the textual information appear in the dictionary and directs the outgoing message to the recipient, Otherwise, the outgoing message is rejected and the sender is notified that the outgoing message comprises un-permissible words. Whenever a predetermined payment is collected from the sender or from the recipient, the sender is allowed to identify himself, or the sender and the recipient are allowed to exchange messages using any words.

Preferably, the host is an Internet Website brokering between users of common interests. Some of the permissible words in the dictionary may only be used under preset restrictions. The dictionary may be stored locally on the user's computer or on the hosting website.

Preferably, the permissible words exclude characters identifying the sender or any contact details.

### BRIEF DESCRIPTION OF THE DRAWINGS

In the drawings:

FIG. 1 is a flow chart generally illustrating an embodiment of the method for monitoring, detecting and preventing the sharing of contact details within the permissible information exchange in a hosting Website.

FIG. 2 is an illustrated example of a messaging page in a “broker” Website according to one of the embodiments.

FIG. 3 is a flow chart generally illustrating another embodiment of the invention where the designated dictionary may be located at the hosting Website or downloaded to the user's computer.

FIG. 4 is a block diagram of another embodiment of the invention where the monitoring and verifying services are handled by a third party.

### DETAILED DESCRIPTION OF PREFERRED EMBODIMENTS

In order to allow the exchange of permissible words only, between users meeting in a hosting Website, the invention uses a designated electronic dictionary, which is actually a list of permitted words. Only the words appearing in the designated dictionary are permitted for use in the messages exchanged between the users. The written messages exchanged between the users are monitored for verifying that they solely contain the permissible words of the designated dictionary. Upon finding a word that does not appear in the dictionary, the user is required to replace the impermissible word before the message may be sent to another user.

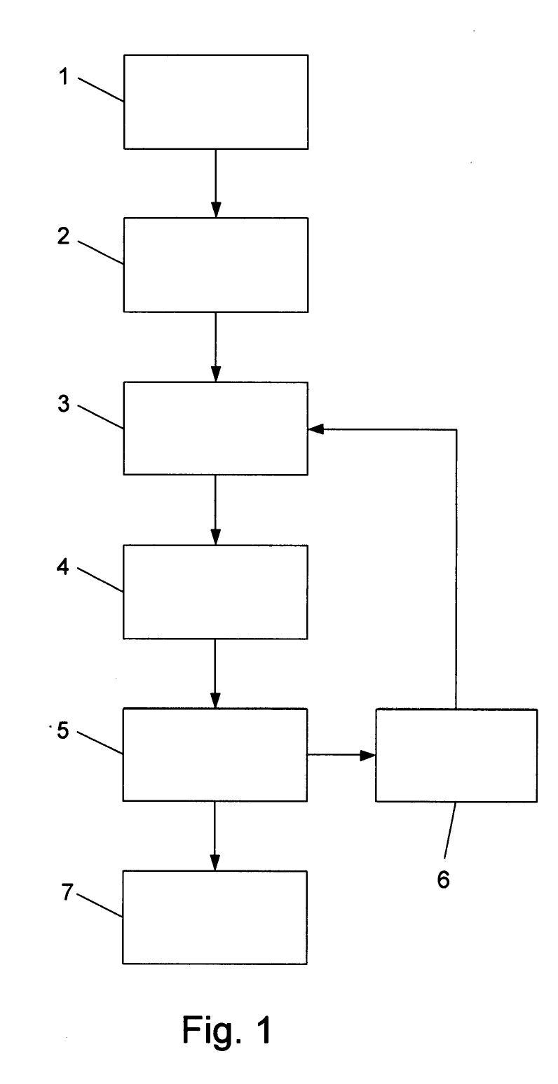

FIG. 1 is a flow chart generally illustrating an embodiment of the method for monitoring, detecting and preventing the sharing of contact details within the permitted information exchange in a hosting Website. In step 1 the user registers on the hosting Website, where the hosting Website may be any kind of a “broker” Website designated to bring users of common interests together, such as: match-making sites, deal sites for selling and buying, employment recruitment sites, fund raising sites, investment sites for investors and companies, and so on. The registration may require the user to disclose: personal details, business details and/or contact details. At this stage the registration details are not shared with other users of the Website and they are safely stored by the Website in a database. After registration, the user may be given an identification “nickname”, or any other username handle, for entering and using in the Website. In step 2 the user may enter and browse the Website looking at the advertised offers. While browsing the Website, the user may wish to receive more information regarding one of the posted offers by sending a question or message. In step 3 the user may formulate and type a message containing a question regarding the posted offer, in a specifically designed location within the Website. The message must include the user's nickname, a question or comment, and the nickname of the message addressee. In step 4 the message words are verified by the Website using the designated dictionary. The message words may be checked during typing or after the user has finished typing the message, or any other possible combination. The designated dictionary may be a general dictionary or a specific dictionary assembled particularly for the Website. Furthermore, the Website may have more than one dictionary with different sets of permitted words according to different user privileges. In step 5 the Website decides how to deal with the message; if impermissible words are used in the message then they are highlighted in step 6, and the message is returned to the user for amending. Once the user has amended the message in step 3, the message is checked again using the designated dictionary in step 4. The process may be continued until the user has amended all the impermissible words. When all the words in the message are verified by the designated dictionary, the message is sent to the addressee of the message in step 7. If the addressee wishes to respond to the message, he may be required to create a message in a similar manner, where the message is also checked in a similar manner. In one of the embodiments, the users are limited to a number of messages according to their privileges. After paying a fee, the Website may give each of the users their counterparts contact details, or full communication privileges to enable them to communicate and discuss the offers in any detail, without further hindrance.

As understood, reference of the user in the Website may be done without using a nickname or a contact handle. The system may allow communication between two users who are completely username blind. The user may send a question to an offer, and the offer originator may respond to the question received, where the system is responsible for delivering the messages between the users. Furthermore, the system may attach an addressee to a message, for signaling the destination of the message, without the knowledge of the sender or the receiver. Therefore, any form of unique identification such as a nickname, or an unseen identification, is referred to hereinafter as “nickname”.

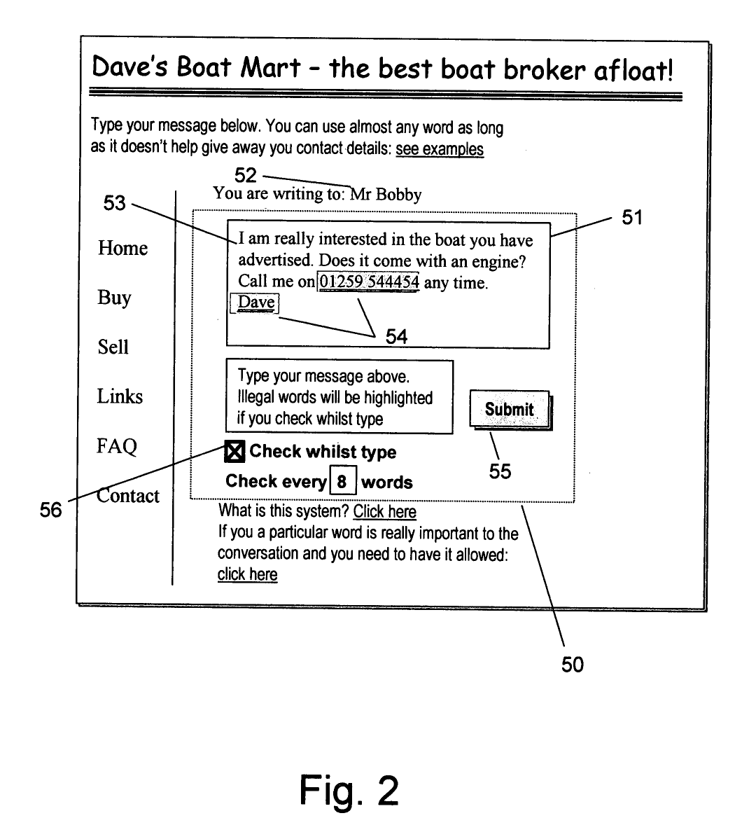

FIG. 2 is an illustrated example of a messaging page in a “broker” site according to one of the embodiments. In this example, the user read an offer for a boat, posted in the Website, by nickname “Mr Bobby”, and he wishes to receive more information. The user may create a message to “Mr Bobby” 52 in the specifically designed text box 51 in the Website, with the question 53 regarding the boat. Since the words 54 (phone number and name) do not appear in designated dictionary and are therefore impermissible words, they are highlighted for the user to amend. An attempt to press the submit button 55 before amending the message might send the message without the highlighted words 54 or might not send the message at all, depending on the Website's regulations. The user may amend the message by deleting or modifying the highlighted words 54 and then pressing the submit button 55. If all the message words appear in the designated dictionary, the message is sent to Mr Bobby, via e-mail or any other electronic communication, according to the Website regulations. The visible components within the dotted box 50 are customizable and may vary from user to user or from Website to Website. The message may be monitored word by word or a number of words at a time as specified by the user or the web site. For example, as can be seen 56 the user selected the option of monitoring every 8 words while he is typing.

In one of the embodiments, some of the dictionary's words are marked and may be limited for use under certain circumstances. For example the digits are permissible in small quantities, meaning that “model 95” may be permissible but “999-9876” may be impermissible. According to another embodiment, the words of the messages between the users are verified by a smart algorithm utilizing the designated dictionary. For example, the use of the word “I” is permitted by the dictionary, however the algorithm allows the use of “I” only in separation from other “I”s, meaning that the sequence “III” may be impermissible (as this may try and communicate the number 3). In another example parenthesis may be permissible only when containing a sentence, since “( )” might hint zero.

In another embodiment, the message may be given a score based on the quantity and type of non permissible words. The sending of the message is then determined based on the value of the score and the permitted score for that user.

The designated dictionary of the invention used for determining the permissible words in messages between the users, may be located at the hosting Website or downloaded to the user's computer either from the Website or from a third party's server. In the case where the dictionary is downloaded to the user's computer the message may be verified using the local dictionary, for saving time and computational resources of the Website.

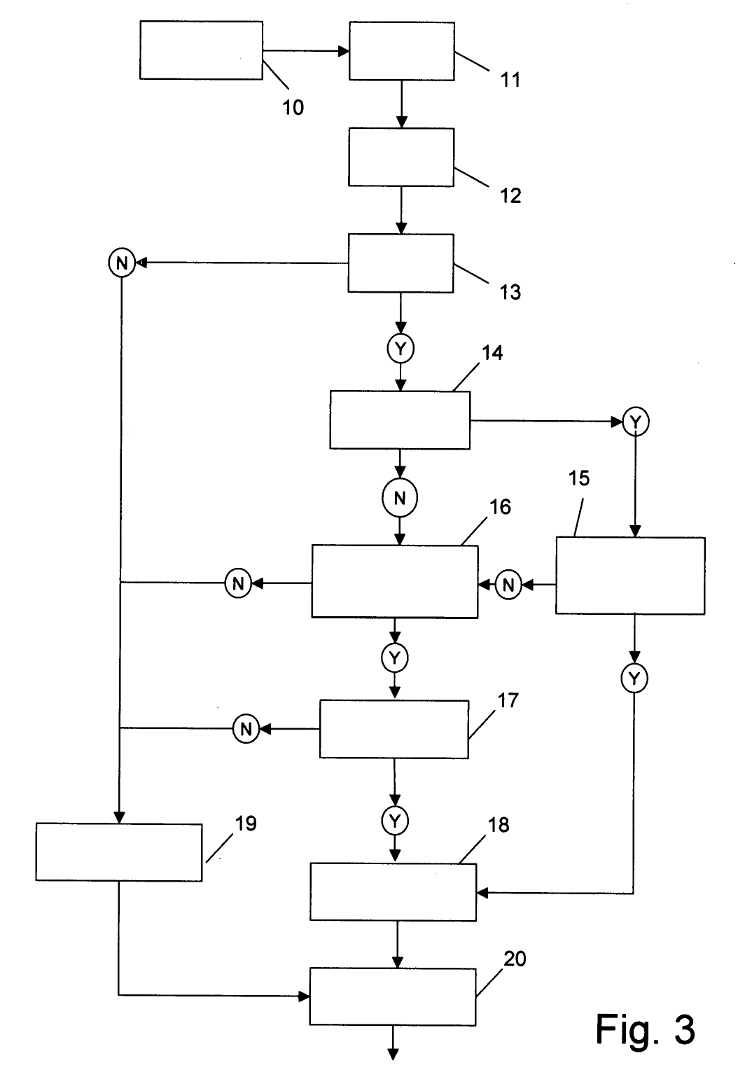

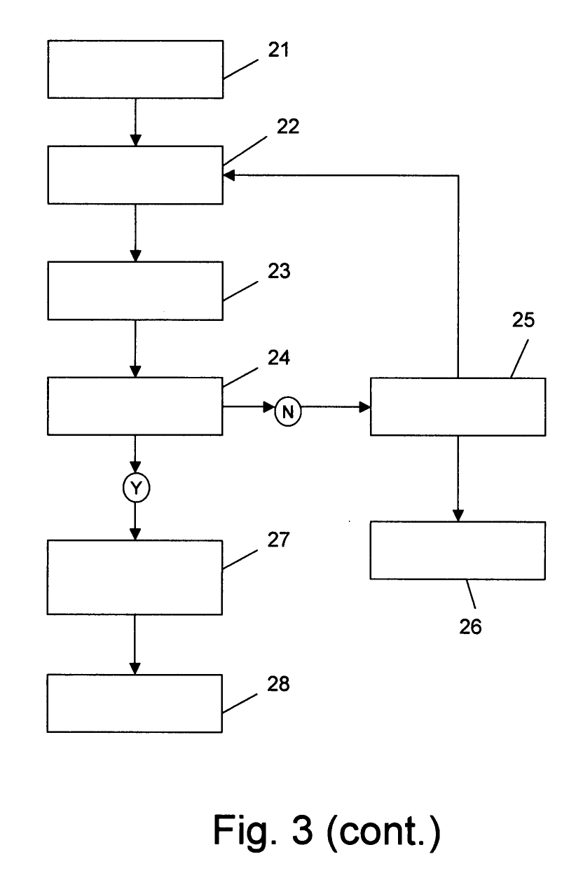

FIG. 3 is a flow chart generally illustrating another embodiment of the invention where the designated dictionary may be located at the hosting Website or downloaded to the user's computer. In step 10 the user registers on the hosting Website, where the hosting Website may be any kind of “broker” Website designed to broker and connect between users. After registration, an electronic dictionary, as defined before, may be downloaded from the hosting Website to the user's computer. The dictionary may be a standard list of words or it may be specifically assembled for the Website and/or according to the user's privileges. For example, a user willing to pay in advance may be allowed a higher level of privilege, meaning that his designated dictionary may contain more words. The dictionary is downloaded with a unique key which is created specifically for the user. In addition, a program or algorithm, for utilizing the dictionary or as an interface, may also be downloaded. At this point the registered user may be given an identification “nickname” for entering the Website. In step 11 the user enters the Website using his nickname, which is associated with his privilege level. In step 12 the user may wish to send a message to one of the other users. In step 13 the Website determines if the use of a locally stored dictionary is allowed. If a local dictionary is allowed, step 14 checks if the local dictionary is installed on the user's computer. If the local dictionary is installed, in step 15 the Website validates the local dictionary on the user's computer. If the local dictionary is not validated as being the correct dictionary to use or the local dictionary has not been installed, the user is asked in step 16 if he wants to download the local dictionary or its updates. If the user agrees, the download may be installed on the user's computer in step 17. In step 18 if the local dictionary is validated correctly or the dictionary has been installed correctly, the Website is instructed to use the local dictionary. If in any of the previous steps the local dictionary has not been validated, the Website is instructed to use the remote dictionary located at the Website or on a third party server in step 19. In step 20 the user may enter a message in the text box specifically designed for entering messages on the Website. In step 21 the Website checks the verification settings of a message either with a local dictionary or a remote dictionary. In step 22 the message words are verified with the dictionary and the impermissible words are highlighted for the user to amend. In step 23 the user may press submit. In step 24 the Website determines if the message is verified. If the message has impermissible words or is disallowed for some other reason as described above, meaning that the message has not been verified, the message is returned to the user in step 25 for amending and verifying as described in steps 22 to 24. In step 26 the impermissible words are stored for later analysis. If the message is verified as having only permissible words in step 24, it is forwarded to the recipient in step 27. A record of the message may be saved in step 28 for monitoring or billing purposes.

In one of the embodiments, the dictionary validating process is done by reading any of the unique key of the dictionary, the last date the dictionary was modified, or the file size of the dictionary. The unique key prevents users from sharing dictionaries between themselves, whereas the date and size of the dictionary determines if the dictionary has been tampered with. As described above, in case the dictionary is out of date the user is prompted to download an update, in which case a new key is generated. Other methods of dictionary validating may be used as well.

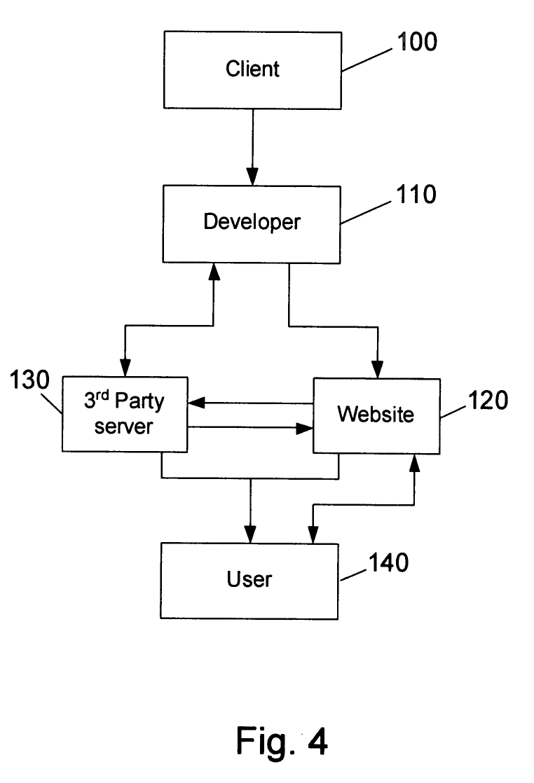

FIG. 4 is a block diagram of another embodiment of the invention where the monitoring and verifying services are handled by a third party. The third party may sell message verifying services to many broker Websites instead of requiring each site to deal alone with users information exchange. In block 100 the party operating the broker Website, referred to hereinafter as client, determines the parameters of the verifying services. For example, the client decides if a local dictionary can be used or a remote hosting dictionary should be used. In block 110 the developer installs a code in the client Website 120 and configures the code according to the client requirements. In addition, the developer configures the third party server 130 according to the client requirements. In block 120, the client broker Website displays a message composition page, for exchanging information between users. If the user, block 140, wishes to browse the client Website 120 and compose a message to another user, he may compose the message in the specially designed page in the client Website 120. The client Website 120 may pass the message to the third party server 130 where the message is verified and returned to the Website 120. If the client selected the use of local dictionary, the user may be prompt to download the dictionary from the third party server 130 through a link in the Website 120. Furthermore, the third party server 130 may manage some of the client account monitoring services, including editing of the dictionaries, saving the messages of the users and billing them accordingly and so on.

As understood, the term “contact details” may include any details which the hosting party wishes to limit including any of the following personal details: such as name, phone number, e-mail address, home address, or other details: such as a location of a meeting place, or details of a third party.

In one of the embodiments, the described method may be used to limit the language used in communications between users of a Website, such as chat rooms, in order to prevent foul language.

In another embodiment, the dictionary is modifiable, and the Website may receive requests to add words to the dictionary from the users. The words may be added to the personal dictionary of the user or to the general dictionary of the site.

In another embodiment, the broker Website may not be responsible for sending the messages. The broker Website's only task may be to verify the messages using the described techniques, and pass the result of the verification to another party. The other party may then be responsible for making the decision on whether to pass the message and subsequently performing the message exchange.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for exchanging permissible information between a user being the sender and a user being the recipient, that are connected to a data network through a hosting website that is connected to said data network, comprising:
a. providing means for exchanging textual information between said sender and said recipient;
b. providing an electronic dictionary, connected to said data network, and containing a set of permissible words, excluding any combination of characters that are not permitted by said hosting website;
c. allowing said sender to compose an outgoing message containing said textual information;
d. whenever said sender sends said outgoing message to a recipient:
e. redirecting said outgoing message to said hosting website;
f in said hosting website, verifying that the words used in said textual information appear in said dictionary and directing said outgoing message to said recipient; otherwise,
g. rejecting said outgoing message and notifying said sender that said outgoing message comprises un-permissible words;
h. whenever a predetermined payment is collected from said sender or recipient, allowing said sender to identify himself or allowing said sender and said recipient to exchange messages using any words.

2. A method according to claim 1, where the host is an Internet Website brokering between users of common interests.

3. A method according to claim 1, where some of the permissible words in the dictionary may only be used under preset restrictions.

4. A method according to claim 1, where the dictionary is stored locally on the user's computer.

5. A method according to claim 1, where the dictionary is stored on the hosting website.

6. A method according to claim 1, where the permissible words exclude characters identifying the sender.

7. A method according to claim 1, where the permissible words exclude contact details.

8. A method according to claim 1, substantially as described and illustrated.
